(19) United States
(12) Patent Application Publication
(10) Pub. No.: US 2015/0127417 A1
(43) Pub. Date: May 7, 2015

(54) SYSTEMS AND METHODS FOR FORECASTING FINANCIAL RISK

(71) Applicant: GEORGIA STATE UNIVERSITY RESEARCH FOUNDATION, INC., Atlanta, GA (US)

(72) Inventors: Richard Philips, Roswell, GA (US); Glenn Harrison, Atlanta, GA (US); George Zanjani, Atlanta, GA (US); Barry Wood, Alpharetta, GA (US); James Todd Swarthout, Decatur, GA (US); Richard Luger, Atlanta, GA (US)

(21) Appl. No.: 14/405,944

(22) PCT Filed: Jun. 6, 2013
(86) PCT No.: PCT/US2013/044476

§ 371 Date: Dec. 5, 2014

Related U.S. Application Data
(60) Provisional application No. 61/656,365, filed on Jun. 6, 2012.

(51) Int. Cl. G06Q 10/06

(52) U.S. Cl. CPC G06Q 10/0635
USPC 705/7.28

(57) ABSTRACT

In one embodiment, forecasting financial risk includes eliciting from multiple risk experts subjective probability distributions regarding the future of a risk index, generating a pooled subjective probability distribution for the index based upon the individual subjective probability distributions, and presenting the pooled subjective probability distribution to users.

### CROSS-REFERENCE TO RELATED APPLICATION(S)

This application claims priority to co-pending U.S. Provisional Application Ser. No. 61/656,365, filed Jun. 6, 2012, which is hereby incorporated by reference herein in its entirety.

### BACKGROUND

It is apparent from the economic journalism of 2006, 2007, and early 2008 that financial experts existed who anticipated that a financial crisis was likely to occur. Although they may not have known precisely what would occur or when, they at least anticipated enough of the specific issues that actually occurred that, if one had heeded their warnings, significant financial damage could have been avoided.

Although these financial experts provided warnings about the impending financial crisis, many individuals and companies were adversely affected by the financial crisis of 2008 and the economic collapse that followed. This may have occurred, at least in part, because of the lack of clear measure of the risks to the economy based upon the opinions of well-respected risk experts. If such a measure had existed, it is possible that many who were harmed in the economic collapse would have taken actions that would have at least reduced the amount of financial damage that they sustained.

In view of the above discussion, it can be appreciated that it would be desirable to have a measure of financial risk that is based upon the beliefs of multiple respected market-neutral risk experts.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a schematic diagram of an embodiment of a system for forecasting financial risk.

FIG. 2 is a block diagram of an embodiment of a central computer shown in FIG. 1.

FIG. 3 is a flow diagram of an embodiment of a method for forecasting financial risk.

FIG. 4 is a flow diagram of an embodiment of a method for eliciting opinions from risk experts as to financial risk.

FIG. 5 is a flow diagram of an embodiment of a method for generating a measure of financial risk.

FIGS. 6A-6G are screen shots of an embodiment of an elicitation interface that can be used to elicit opinions from risk experts.

FIG. 7 is a graph of an example pooled subjective probability distribution for a risk index.

FIGS. 8A and 8B are graphs of pooled subjective probability distribution curves of a risk index.

FIG. 9 is a flow diagram of an embodiment of a method of rewarding risk experts for correctly forecasting financial risk.

FIG. 10 comprises graphs of actual statistical forecasts and pooled subjective beliefs for three equity indices.

FIG. 11 comprises graphs of actual statistical forecasts and pooled subjective beliefs for three interest rates.

FIG. 12 comprises graphs of actual statistical forecasts and pooled subjective beliefs for three financial indices.

FIG. 13 comprises graphs of actual statistical forecasts and pooled subjective beliefs for two commodity prices.

### DETAILED DESCRIPTION

As described above, it would be desirable to have a measure of financial risk that is based upon the beliefs of respected market-neutral risk experts. Disclosed herein is such a measure that takes the form of a risk index. In some embodiments, the risk index comprises a forecast for multiple individual market indices. By way of example, the indices comprise some of the most commonly tracked financial indices, such as the S&P 500 and the sport price of gold. The forecasts for the indices are generated by eliciting the subjective beliefs of a group of respected market-neutral risk experts of major global financial institutions. In some embodiments, a subjective probability distribution is obtained from each expert as to the future of each index and the probability distributions are aggregated to obtain a pooled subjective probability distribution that identifies the likelihood of different potential levels of the index sometime in the future (e.g., one year from present date). In some embodiments, the pooled subjective probability distributions are published along with an indication of the degree to which each individual expert agrees with the pooled opinion of the group.

In the following disclosure, various specific embodiments are described. It is to be understood that those embodiments are example implementations of the disclosed inventions and that alternative embodiments are possible. All such embodiments are intended to fall within the scope of this disclosure.

One set of persons who are most likely to have “expert” views on the financial risks facing a particular market are arguably those who are well paid to provide advice on the management of those risks for large corporations and those who do not have positions in that particular market, i.e., chief risk officers (CROs). It is for this reason that those persons should be consulted to provide subjective belief distributions about core financial risks.

Subjective beliefs can be defined by the choices that individuals make when facing bets whose outcomes depend upon those beliefs. To observe these choices, experiments were conducted using proper scoring rules, which are simply structured bets offered to the individual by an observer (the experimenter). All of the elicited beliefs were incentivized and incentive-compatible, so that the CROs were making real choices with real economic consequences.

A byproduct of this characterization is that one can also say something about the degree of consistency in the subjective beliefs that a sample of CROs have about some financial risk. It may be that the pooled belief distribution does not change from month to month, but underlying that stationary, pooled distribution are some individuals with significantly tighter beliefs and some individuals with significantly more diffuse beliefs. Those differences are valuable information, signaling that there is less consistency in the sample of experts than in the previous month, despite the pooled distribution being the same.

Below, subjective belief distributions are compared with statistical forecasts resulting from the application of standard econometric models. The statistical forecasts are not believed to be better than those provided by professional forecasting firms, but they do follow “state-of-the-art” methods. Their purpose is to provide a transparent basis for evaluating the information content of the subjective beliefs. If the subjective beliefs are consistent with the statistical forecasts, then one can presumably have greater confidence in both, implicitly pooling these information sources in a Bayesian manner.

Eleven (11) financial risks were selected to span equity risk, interest rate risk, currency risk, credit risk and commodity risk. Each of these risks take the form of a risk index (financial index) that is described below.

1. The S&P 500 Index. Standard and Poor's 500 Index is a capitalization-weighted index of 500 stocks. The index is designed to measure performance of the broad domestic economy through changes in the aggregate market value of 500 stocks representing all major industries. The index was developed with a base level of 10 for the 1941-1943 base period. The return does not include dividends paid and is the final price divided by the starting price minus 1, quoted in percent. The Bloomberg terminal ticker symbol is SPX.

2. The Eurostoxx 50 (European Blue Chip, excluding the U.K) Index. This is a free-float market capitalization-weighted index of 50 European blue-chip stocks from those countries participating in the EMU. Each component's weight is capped at 10% of the index's total free-float market capitalization. The index was developed with a base value of 1000 as of Dec. 31, 1991. The return does not include dividends paid and is the final price divided by the starting price minus 1, quoted in percent. The Bloomberg terminal ticker symbol is SX5E.

3. The MSCI AC Asia (excluding Japan) Index. This is a free-float weighted equity index. It was developed with a base value of 100 as of Dec. 31, 1987. The return does not include dividends paid and is the final price divided by the starting price minus 1, quoted in percent. The Bloomberg terminal ticker symbol is MXASJ.

4. The 10-Year U.S. Treasury Bond Yield. This is the yield to maturity of on-the-run 10-year United States Treasury Bonds. The Bloomberg terminal ticker symbol is GT10.

5. The 10-Year German Bund Yield. This is the yield to maturity of on-the-run 10-year German Bund, which are government bonds. The Bloomberg terminal ticker symbol is GTDEMIOTR.

6. The 10-Year Japanese Government Bond Yield. This is the yield to maturity of on-the-run 10-year Japanese Government Bonds. The Bloomberg terminal ticker symbol is GJGB10.

7. The Euro/USD Exchange Rate, quoted as $ per [symbol] . The Bloomberg terminal ticker symbol is EURUSD.

8. The CDX North American Credit Default Swap Index. The Markit CDX North America Investment Grade Index is composed of 125 equally weighted credit default swaps on investment grade entities, distributed among 6 sub-indices: High Volatility, Consumer, Energy, Financial, Industrial, and Technology, Media and Telecommunications. Markit CDX indices roll every 6 months in March and September. This is the quoted spread on the 5-year basket credit derivative, with a coupon value of 100 bps. The Bloomberg terminal ticker symbol is IBOXUMAE.

9. The iTraxx European Credit Default Swap Index. The Markit iTraxx Europe Crossover index comprises 50 equally-weighted credit default swaps on the most liquid sub-investment-grade European corporate entities. The composition of each Markit iTraxx index is determined by a liquidity poll and certain criteria as determined by the index rules. The Markit iTraxx indices roll every 6 months in March and September. This is the quoted spread on the 5-year basket credit derivative, with a coupon value of 500 bps. The Bloomberg terminal ticker symbol is ITRXEXE.

10. Brent Crude Oil Price. The price of current pipeline export quality Brent blend as supplied at Sullom Voe. The InterContinentalExchange (ICE) Brent Futures is a deliverable contract based on Exchange of Futures for Physical (EFP) delivery with an option to cash settle. The contract price is in US dollars and cents per barrel. The Bloomberg terminal ticker symbol is CO1.

11. The Gold Spot Price is quoted as U.S. Dollars per Troy Ounce. The Bloomberg terminal ticker symbol is GOLDS.

These indices span a range of the core financial risks affecting a wide range of global corporations.

There are many hypothetical surveys that elicit probabilistic forecasts for various events, where the term “probabilistic” is used in the general sense to refer to any attempt to elicit a probability. Once way this can be accomplished is to elicit subjective probabilities to binary events. For instance, a widely used subjective belief question comes from the U.S. Health and Retirement Survey, which since 1992 has asked a simple question for respondents under the age of 65: “With 0 representing absolutely no chance, and 100 absolute certainty, what is the chance that you will live to be 75 years of age or older?” A comparable question asked the chance that they would live to be 85, and for respondents over 65 a variant asked the chances of them living 11-15 years more. Similar questions can and have been asked about financial indices (for example returns on the S&P 500 in hypothetical surveys of Chief Financial Officers and U.S. households).

There have also been many hypothetical surveys eliciting complete distributions over some event. Prominent examples include the U.S. Survey of Professional Forecasters and beliefs about GDP and inflation and the RAND American Life Panel Survey and beliefs about inflation.

Employed in the current methodology is an explicit scoring rule to elicit reports that reveal the subjective belief distribution of CROs. An important feature of the approach is that individuals face incentives to truthfully reveal their entire subjective distribution. Instead of only eliciting subjective probabilities binary of events occurring, whole distributions that reflect the confidence with which those events are expected are elicited. In addition, hypothetical survey responses are not relied upon to encourage truthful and reflective responses.

In some embodiments, a CRO (subject) reports his or her subjective beliefs in a discrete version of a quadratic scoring rule (QSR) for continuous distributions, which was first developed by Matheson and Winkler [1976]. With such a rule, the domain is partitioned into K intervals that denote as rₖ the report of the density in interval k=1, . . . , K. Assume that the subject is risk neutral and that the full report consists of a series of reports for each interval, {r₁, r₂, . . . , rₖ, . . . , r_{K}} such that rₖ≧0∀k and Σ_{i=1 K}(rᵢ)=1.

If k is the interval in which the true value lies, then the payoff score is from Matheson and Winkler [1976; p.1088, equation (6)]:

S=(2×rₖ)−Σ_{i=1 . . . K}(rᵢ)²

The reward in the score is a doubling of the report allocated to the true interval and a penalty that depends upon how these reports are distributed across the K intervals. The subject is rewarded for accuracy but, if that accuracy misses the true interval, the punishment is severe. The punishment includes all possible reports, including the correct one.

Consider some examples, assuming K=4. Assume the subject can allocate a finite number of tokens to different outcomes. What if the subject has very tight subjective beliefs and puts all of the tokens in the correct interval? Then the score is

S=(2×1)−(1²+0²+0²+0²)=2−1=1,

and this is positive. However, if the subject has a tight subjective belief that is wrong, the score is

S=(2×0)−(1²+0²+0²+0²)=0−1=−1,

and the score is negative. One can see that this score would have to include some additional “endowment” to ensure that the earnings are positive. Assuming that the subject has a very diffuse subjective belief and allocates 25% of the tokens to each interval, the score is less than 1:

S=(2×¼)−(¼²+¼²+¼²)=½−¼=¼<1.

The tradeoff from the last case is that one can always ensure a score of ¼, but there is an incentive to provide less diffuse reports and that incentive is the possibility of a score of 1.

To ensure complete generality and avoid any subject facing losses, allow some endowment, a, and scaling of the score, 3. One then obtains the generalized scoring rule

α+β[(2×rₖ)−Σ_{i=1 . . . K}(rᵢ)²]

where α=0 and β=1 is initially assumed. One can assume α>0 and β0 to get the payoffs to any level and units that are desired.

In the elicitation procedures K=10, it is unknown whether or not the subject is risk neutral. Indeed, the weight of evidence from past laboratory and field experiments clearly suggests that subjects will be modestly risk averse over the prizes they face. Risk aversion can significantly affect inferences from applications of the QSR to eliciting subjective probabilities over binary events and there are various methods for addressing these concerns. Some have characterized the implications of the general case of a risk-averse agent when facing the QSR and reporting subjective distributions over continuous events and find, remarkably, that these concerns do not apply with anything like the same force. For empirically-plausible levels of risk aversion, one can reliably elicit the most important features of the latent subjective belief distribution without undertaking calibration for risk attitudes. Specifically, the following conclusions have been drawn:

1. The individual never reports having a positive probability for an event that does not have positive subjective probability. Therefore, if the individual believes that the annual return on the S&P 500 will definitely be below 20.1%, one would never see the individual reporting that it could be above 20.1%. Hence the subject truly attaches zero weight to this possibility, no matter what their risk attitudes.

2. If an individual has the same subjective probability for two events, then the reported probability will also be the same if the individual is risk averse or risk neutral. Therefore, if the individual attaches a true, subjective probability of 0.2 to the chance that the return on the S&P 500 will be between −9.9% and 0%, and a true, subjective probability of 0.2 to the chance that it will be between 10.1% and 20%, the reported probabilities for these two intervals will be the same as well.

3. The converse is true for risk averse subjects, as well as for risk lovers. That is, if one observes two events receiving the same reported probability, it is known that the true probabilities are also equal, although not necessarily the same as the reported probabilities.

4. If the individual has a symmetric subjective distribution, then the reported mean will be exactly the same as the true subjective mean, whether or not the subjective distribution is unimodal. Hence, if one simply assumes symmetry of the true distribution, a relatively weak assumption in many settings of interest, one can elicit the mean belief directly from the average of the reported distribution.

5. The more risk averse an agent is, the more the reported distribution will resemble a uniform distribution defined on the support of their true distribution. In effect, risk aversion causes the individual to report a “flattened” version of their true distribution, but never to report beliefs to which they assign zero subjective probability.

6. It is possible to bound the effect of increased risk aversion on the difference between the reported distribution and true distribution. This result provides a characterization of an empirical finding from incentivized experiments with objectively verifiable stimuli that the reported distribution is “very close” to the true distribution for a wide range of empirically plausible risk attitudes. It has been numerically shown that a priori plausible levels of risk aversion in laboratory and field settings imply no significant deviation between reported and true subjective beliefs in this setting.

Providing that the CROs exhibit the modest levels of risk aversion found universally in lab and field settings for stakes of the level used in the experiments and make their choices solely in response to the incentives provided by the scoring rule, these results provide the basis for using the reported distributions as if they are the true, subjective belief distributions. In an effort to ensure that the true, subjective belief distributions are obtained, a binary lottery procedure first developed by Smith [1961] can be used to encourage individuals to behave as if risk neutral. The application of the binary lottery procedure is described below.

The individuals from which beliefs are to be elicited are valuable employees of major corporations and are compensated accordingly. Compensation packages for a CRO in top corporations are generally $1 million per year and above. In view of this, the question arises as to how one can incentivize such individuals to take their task seriously. It was recognized that relatively small direct payments would not affect the pocketbook of these individuals, so it was instead decided to express the rewards as contributions to a charity. In effect, these contributions are relied upon to encourage respondents to view their efforts as being compensated in the manner of a “gift exchange.”

Research in behavioral economics has shown that it is important that participants face an incentive scheme designed to reward them for taking the task seriously. An incentive mechanism was developed to convert points earned in the elicitation task into a chance of earning money for a charity of the CRO's choice. In one embodiment, the CRO allocates a finite number (e.g., 100) of tokens to a number of bins each associated with a particular level an index is forecast to reach or a particular percentage that the index is forecast to change. For example, if the CRO was confident that the S&P 500 was going to increase 0 to 10% within the next year, he or she could allocate all or the majority of the tokens to a bin associated with that range. Alternatively, if the CRO believed that the S&P 500 was going to increase 0 to 10% but was less certain about this outcome, he or she could allocate some of the tokens to the bin associated with 0 to 10% and other tokens to the bins associated with −10 to 0% and 10 to 20% (i.e., the two neighboring bins).

When the actual future level or percentage falls within a range that the CRO selected, the CRO obtains points related to the number of tokens that were allocated to that range according to the QSR. While the number of points could be directly related to an amount of money to be donated to a charity, it is recognized that the risk involved in allocating the tokens may result in overly conservative allocation that may not most accurately reflect the CRO's beliefs. To make the CROs more neutral to this risk, a binary lottery procedure is used in which the likelihood of money being donated to the charity is based upon both the number of points the CRO scored as a result of his or her allocations as well as random chance. In one embodiment, this is achieved by awarding 0 to 100 points to the CRO and then comparing the point score with a randomly-generated number from 0-100. If the randomly-generated number is less than or equal to the point score, a fixed sum (e.g., $50) is awarded to the charity on the CRO's behalf. If the randomly-generated number is greater than the point score, no charitable contribution is made. With this scheme, the greater the number of points the CRO scores, the greater the chance of a charitable donation being made. However, there is still a chance that no charitable contribution will be made even for relatively high point scores because of the nature of the binary lottery. Because of this, there is an aspect of random chance that reduces the perception of risk for the CRO and results in the CRO allocating tokens according to his or her true subjective beliefs.

In some embodiments, the randomly-generated number can be generated by a random number generating algorithm. In other embodiments, the randomly-generated number can be a number that is publicly generated and over which no one has direct control. For instance, the random number can be the first and second decimals of the closing price of the Dow Jones Industrial Index (DJIA) (“00” treated as “100) on the day the CRO's beliefs are compared to the actual resulting value of the index. As an example, if the DJIA has a closing price of 12,649.35, the random number would be 35 and a charitable contribution would be made on the CRO's behalf if he or she scored 35 points or more because of his or her token allocations. In some embodiments, the CRO is rewarded each month for accuracy for one index that is randomly selected for the CRO. Therefore, the risk on which the CRO is rewarded is independent of other respondents and it will change from month to month.

To understand the logic of this procedure and why it removes the effect of risk aversion, one can normalize the utility of the individual of the payment of $50 to 1, and the utility from the payment of $0 to 0. It is then apparent that the subject has had a linear utility function of money induced, as shown by Smith [1961]. Given the theoretical results referred to earlier, it is predicted that the individual CROs will behave identically to those facing direct monetary payoffs.

These steps to ensure that there were some financial incentives and that they were linked in a salient manner to the responses to the scoring rule might seem elaborate. Although promoting competition or “tournament” between the CROs might appear superficially attractive as a way to motivate, this can quickly distort incentives for truthful reporting. For instance, imagine a setting in which one respondent needs a big score to improve his rank to be #1. Akin to a professional golfer who only cares about winning, and not coming in second, one might expect extreme choices in an attempt to improve the ranking.

Any measuring instrument can be compared against another measuring instrument. Examples include weight scales, political opinion polls, or medical judgments about diagnoses. In this case, of interest are the subjective beliefs about some fact and it is important to measure their consistency. In the biostatistics literature, a popular concordance index ρ_{c} has been developed by Lin [1989][2000]. This index combines the familiar notion of correlation from a Pearson inter-class correlation coefficient with allowance for bias and is virtually identical to measures of intra-class correlation used in psychology. The index is bounded between ±1, with the usual interpretation that ρ_{c}=1 indicates perfect concordance and smaller values indicate poorer concordance.

The concordance index can be applied in two ways. First, the consistency of the pooled subjective belief distribution over all respondents can be evaluated and the predictive distribution from the statistical model can be forecast. Second, the consistency across the different elicited subjective distributions of respondents can be assessed.

Statistical forecasts for the financial indices over the same time period as that for which the CROs provide their opinions can be generated to provide a baseline for judging those opinions. Transparent, familiar, state-of-the-art statistical methods are used for these forecasts because the objective is not to propose some novel statistical forecasting methodology but instead to provide a benchmark that is reasonable. In some embodiments, factor-augmented vector autoregressions (VAR) are used. The VAR model captures linear correlations between multiple economic time series and is widely employed for forecasting financial indices such as these.

The VAR model is a natural generalization of the univariate autoregressive model to dynamic multivariate time series. A univariate autoregression is a single-equation, single-variable linear model in which the current value of a variable is determined by its own lagged values. In a VAR model, all variables are treated symmetrically so that each variable has an equation describing its evolutions over time based on its own lags and the lags of all the other variables appearing in the model. This simple framework provides a systematic way to capture rich dynamics in multiple time series, and the statistical VAR methodology is easy to use and interpret. The factors of the factor-augmented VAR model are simply additional explanatory variables included along with the set of the index variables to be forecast.

The parameters of the VAR models can be estimated using time series of monthly observations. The estimated models can then be used to produce 12-month forecasts of the variables of interest by standard methods. A non-parametric bootstrap procedure can be used to obtain joint predictive distributions. The bootstrap procedure is particularly useful for forecasting purposes because it enables the construction of predictive distributions without assuming any particular distribution for the VAR model disturbances and incorporates the effects of parameter uncertainty.

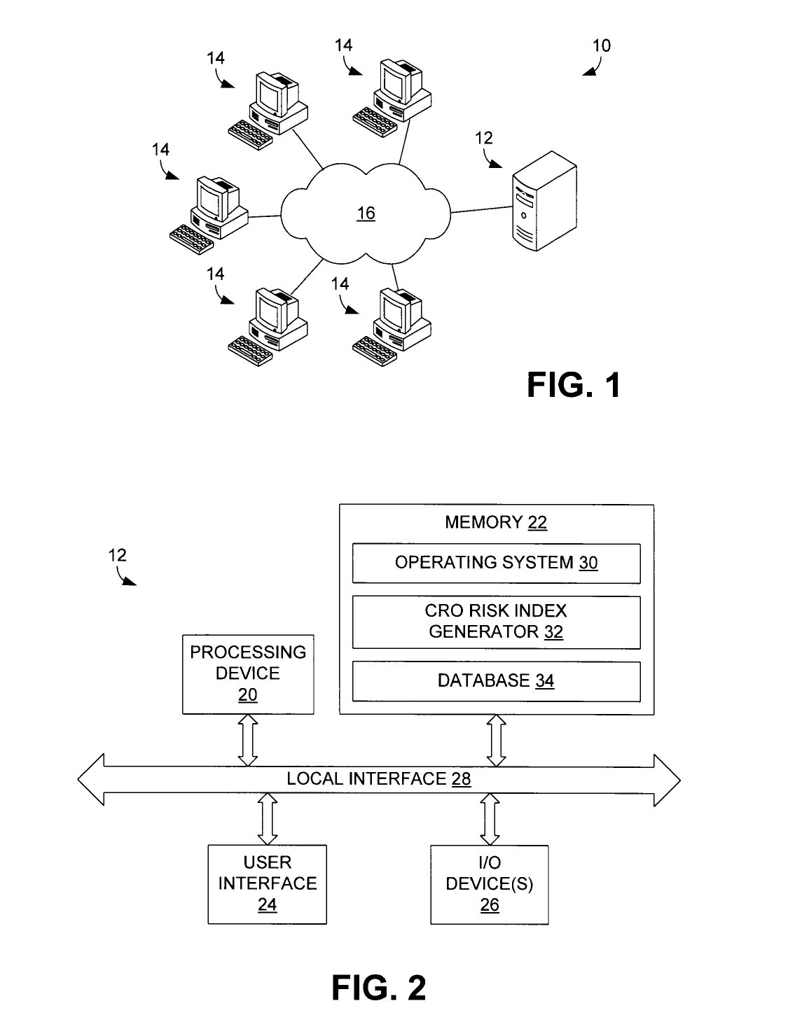

Example systems and methods for forecasting financial risk will now be described in relation to the figures. Beginning with FIG. 1, illustrated is an embodiment of a system 10 with which financial risk can be forecast. As shown in FIG. 1, the system 10 comprises a central computer 12 and multiple remote user computers 14. The central computer 12 can comprise a server computer that is operated by a service that is responsible for producing a risk index (e.g., CRO risk index) that conveys financial risk with forecasts for multiple risk indices (financial indices). One or more of the user computers 14 can be operated by CROs who provide their responses to elicitations issued by the service and one or more of the user computers can be operated by an individual who wishes to view the risk index that results from processing of the responses. Although the user computers 14 are illustrated in FIG. 1 as comprising desktop computers, the user computers can take the form of substantially any device with computing power that can send and/or receive data over a network 16 to which each user computer 14 is connected with the central computer 12. In some embodiments, the network 16 comprises the Internet.

FIG. 2 illustrates an example configuration for the central computer 12 shown in FIG. 1. As is shown in FIG. 2, the central computer 12 includes a processing device 20, memory 22, a user interface 24, and at least one I/O device 26, each of which is connected to a local interface 28.

The processing device 20 can include a central processing unit (CPU) or a semiconductor-based microprocessor (in the form of a microchip). The memory 22 includes any one of or a combination of volatile memory elements (e.g., RAM) and nonvolatile memory elements (e.g., hard disk, ROM, Flash, etc.). The user interface 24 comprises the components with which a user interacts with the central computer 12, such as a keyboard, keypad, and a display screen, and the I/O devices 26 are adapted to facilitate communications with other devices.

The memory 22 (a non-transitory computer-readable medium) comprises programs (logic) including an operating system 30 and a CRO risk index generator 32. In some embodiments, the CRO risk index generator 32 is configured to elicit subjective probability distributions for various risk indices from CROs, process the subjective probability distributions to produce a CRO risk index, and publish the CRO risk index. As is further shown in FIG. 2, the memory 22 further includes a database 34 that stores the data upon which the CRO risk index is generated. In some embodiments, the data is made available to certain users, such as individuals or organizations who purchase a subscription that enables them access to the data.

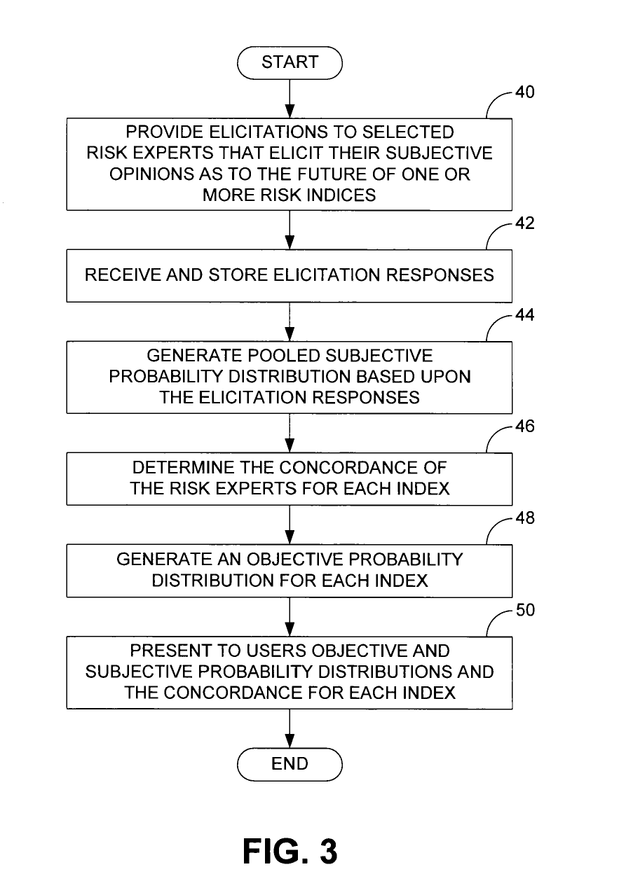

FIG. 3 provides an overview of an example method for forecasting financial risk consistent with the foregoing discussion. One or more of the actions described in relation to FIG. 3 can, at least in some embodiments, be performed by the CRO risk index generator 32. It is noted that, in the flow diagrams of this disclosure, one or more actions identified in the diagrams can be performed in an order other than that shown in the figures.

Beginning with block 40 of FIG. 3, elicitations are provided to selected risk experts that elicit their subjective opinions as to the future of one or more risk indices and, as indicated in block 42, the responses to the elicitations are received and stored. As described above, the risk experts can be CROs of major global financial institutions and the indices can comprise one or more financial indices such as the S&P 500, the Eurostoxx 50 index, the MSCI AC Asia Index, the 10-Year U.S. treasury bond yield, the 10-Year German bund yield, the 10-Year Japanese government bond yield, the Euro/USD exchange rate, the CDX North American credit default swap index, the iTraxx European credit default swap index, the Brent crude oil price, and the gold spot price. Of course, other indices could be used. For example, in other embodiments, the DJIA can be used.

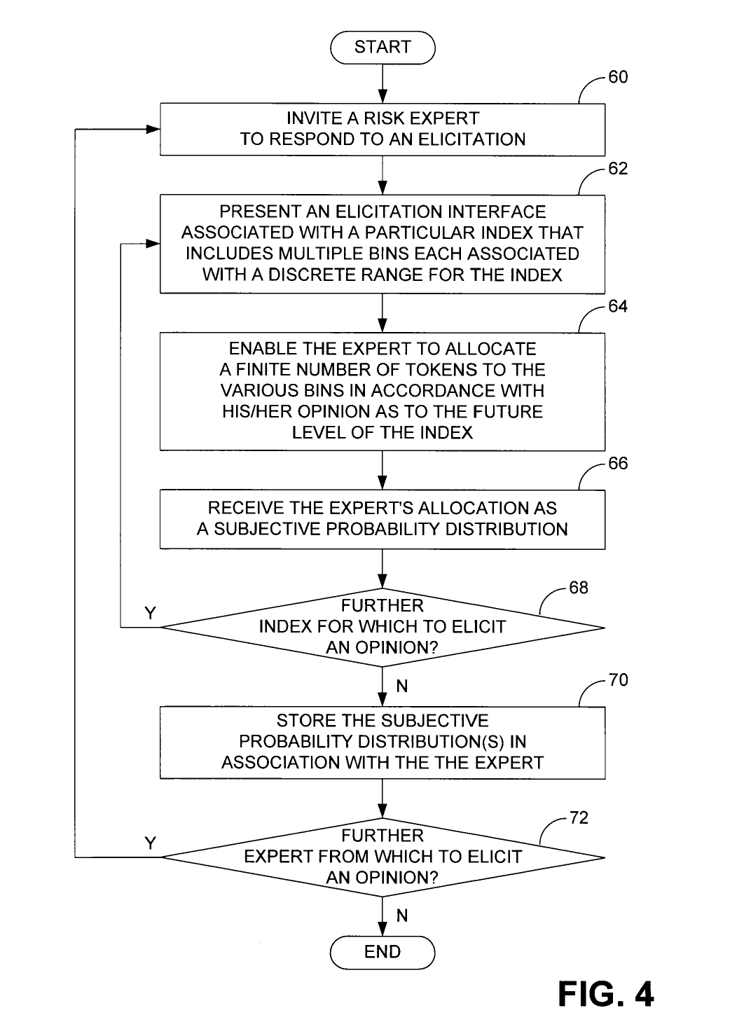

The subjective probability distributions can be obtained in various ways. FIG. 4 describes one example methodology. With reference to block 60 of FIG. 4, the risk expert is invited to respond to an elicitation. In some embodiments, the invitation can be an email invitation that is sent to the risk expert. In cases in which a CRO risk index is to be produced monthly, such an invitation can be sent to the risk expert each month. Irrespective of how frequently the invitation is sent, it can contain a link to a web-based elicitation interface that elicits the risk expert's beliefs as to the future of the risk indices.

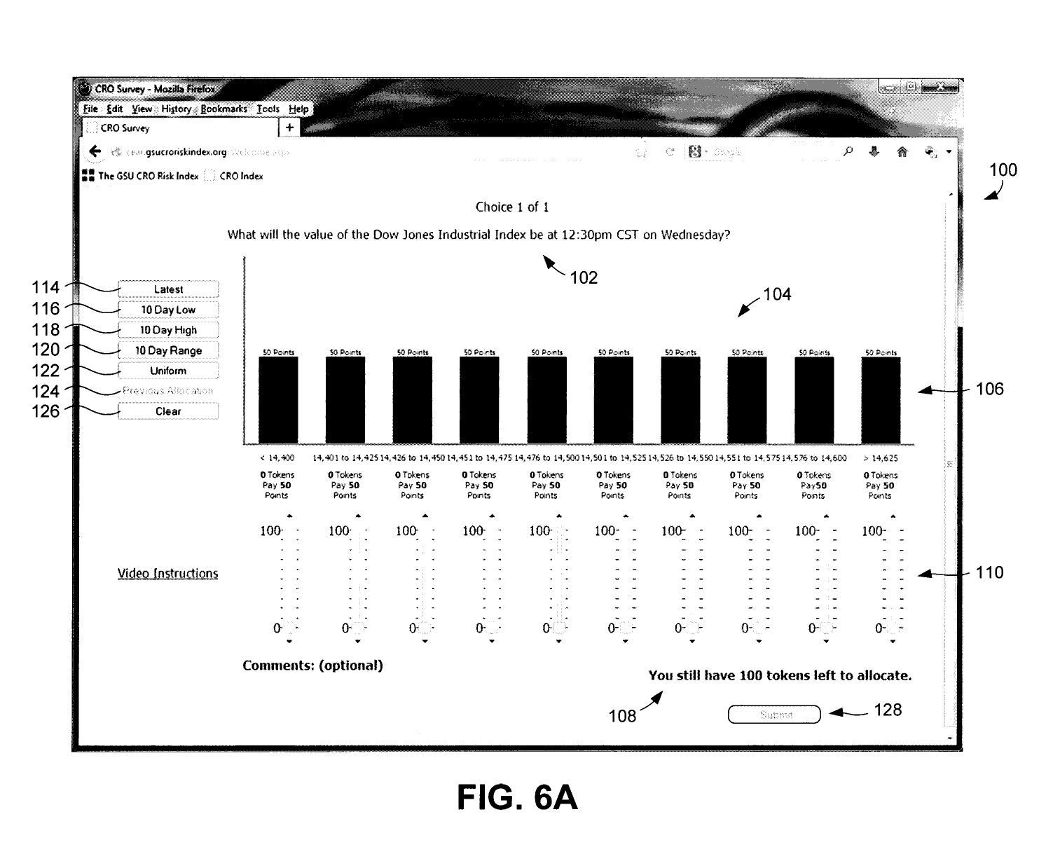

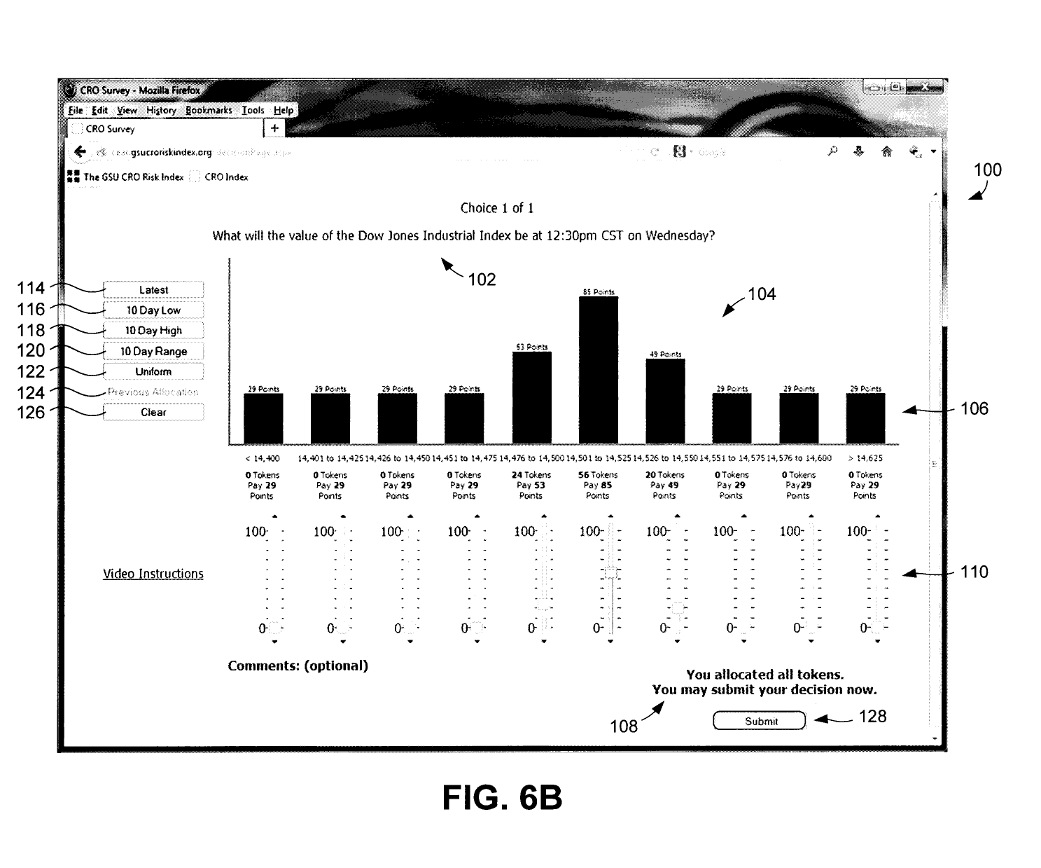

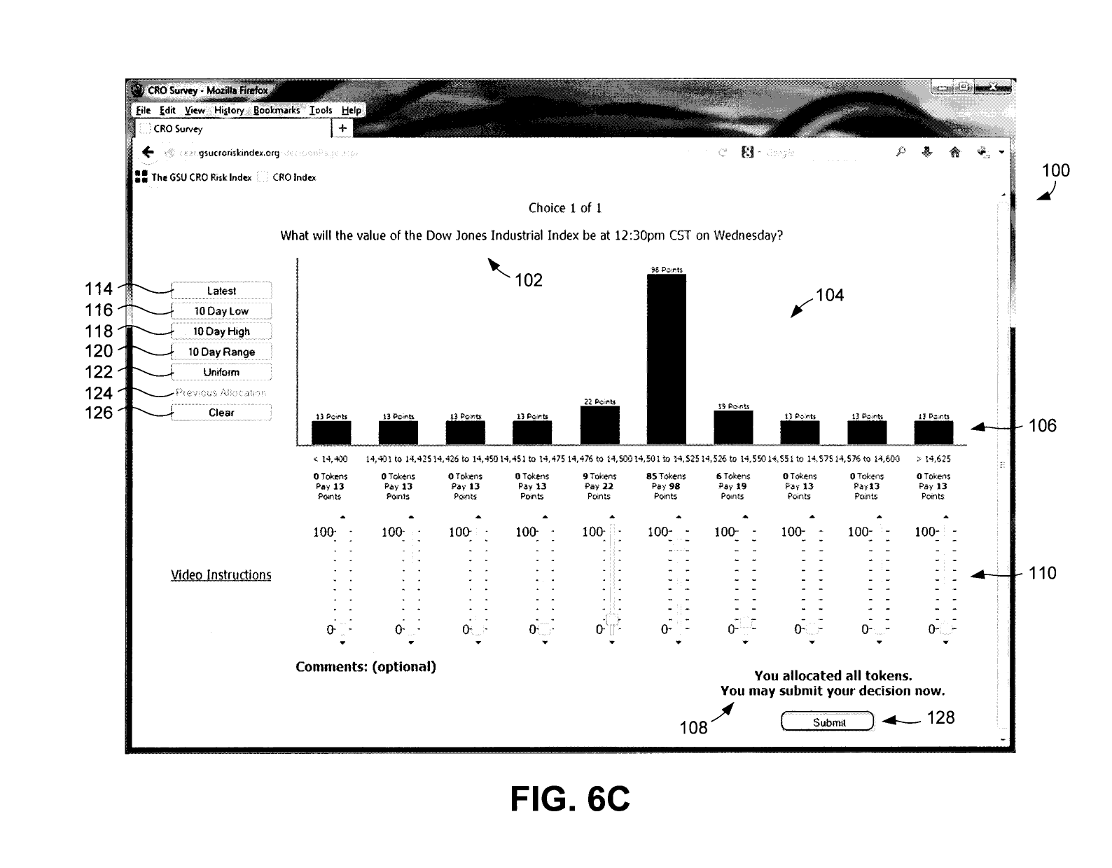

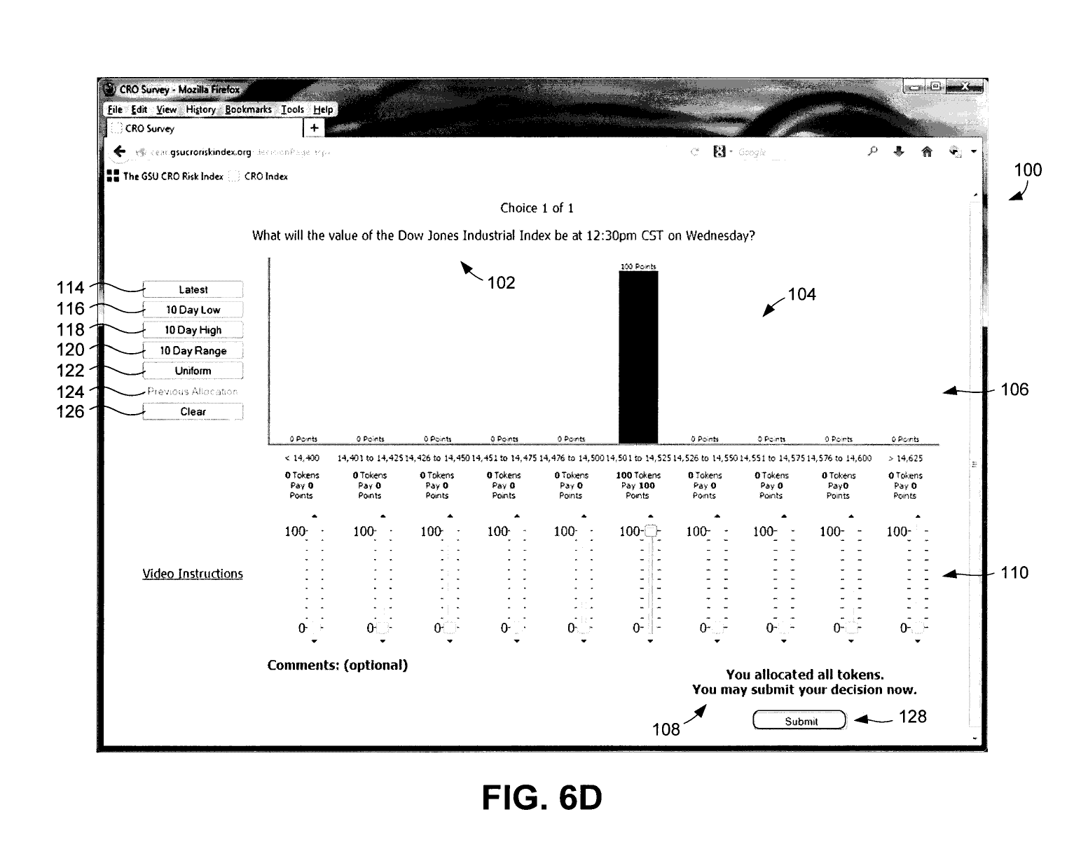

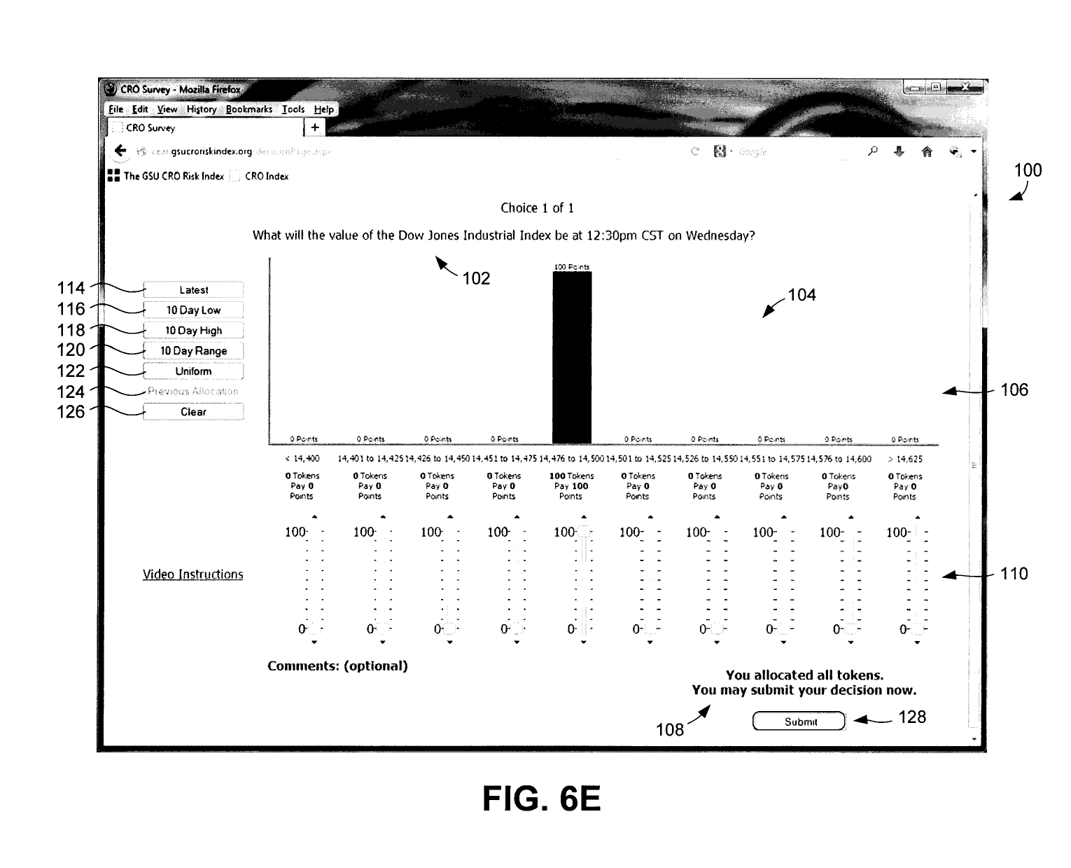

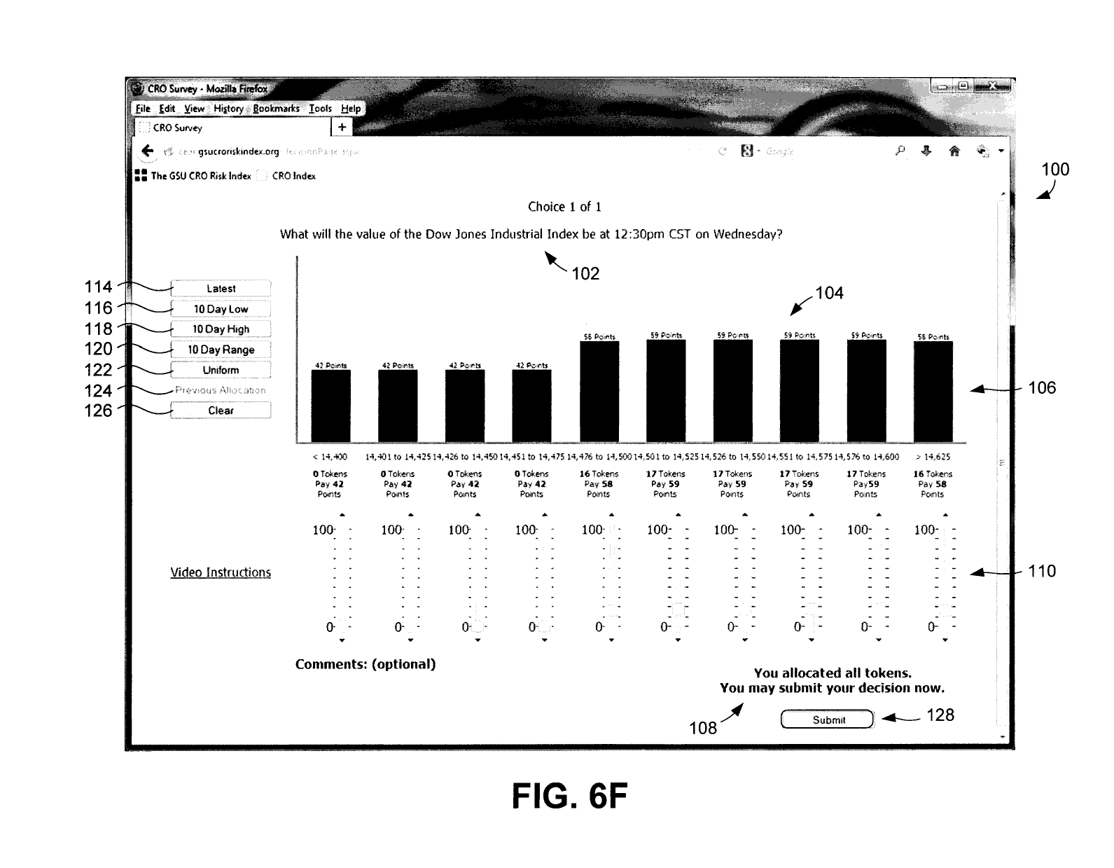

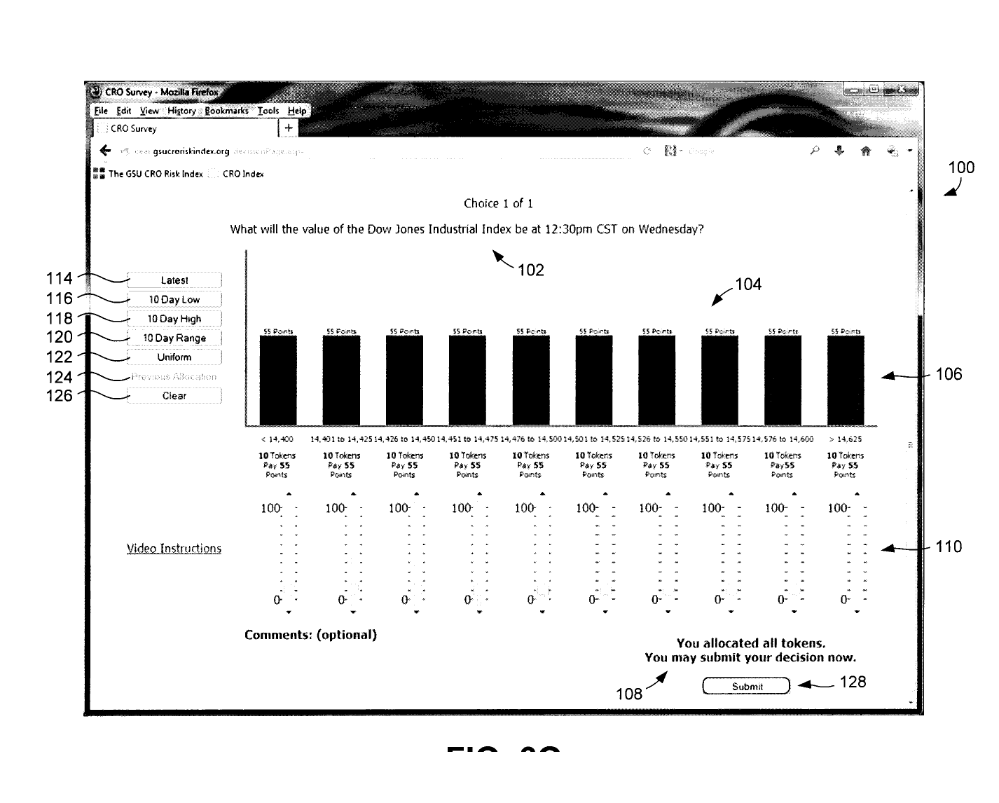

Referring next to block 62, an elicitation interface associated with a particular risk index that includes multiple bins each associated with a discrete future range of values for the index is presented to the risk expert. The expert can then be enabled to allocate a finite number of tokens to the bins in accordance with the expert's belief as to the probability of a future level of the index, as indicated in block 64. FIG. 6A illustrates a screen shot of an embodiment of a web-based elicitation interface 100 that can be used for this purpose. In the example of FIG. 6A, the elicitation interface 100 concerns the future price range of the DJIA, and the question 102 “What will the value of the Dow Jones Industrial Index be at 12:30 pm CTS on Wednesday?” appears at the top of the interface. Below the question 102 are multiple bins 104, each associated with a particular range of DJIA prices. The first bin 104 is associated with a price “<14,400,” the second bin is associated with a price of “14,401 to 14,425,” the third bin is associated with a price of “14,426 to 14,450,” and so forth until the tenth and last bin, which is associated with a price of “>14,625.” As is also shown in FIG. 6A, a level bar 106 is associated with each bin 104 and identifies the number of points currently associated with each bin. In the example of FIG. 6A, there are 50 points associated with each bin 104, meaning that the risk expert will score 50 points if the DJIA price at 12:30 pm CST on Wednesday falls within any of the ranges of the bins.

In some embodiments, the point distribution shown in FIG. 6A, in which 50 points are associated with each bin 104, is an initial default point distribution that exists before the risk expert allocates any tokens. When the risk expert allocates tokens, however, the point distribution changes according to the QSR. In some embodiments, the expert can allocate 100 tokens to one or more of the bins 104 to alter the point distribution. In the illustrated embodiment, the number of tokens that remain to be allocated can be presented to the expert in a text block 108 located below the bins 104. In the example of FIG. 6A, no tokens have been allocated so the text block indicates that all 100 tokens are left to be allocated.

The risk expert can allocate tokens using slide bars 110 that are associated with the various bins 104. Each slide bar 110 identifies the number of tokens (0-100) that are allocated to its associated bin 104. To allocate tokens, the expert moves a slide to increase or decrease the number of tokens a given bin 104 has. FIG. 6B shows an example of this. In FIG. 6B, the slide bar 110 associated with the range “14,501 to 14,525” has been moved upward along the 0-100 scale so that 56 of the 100 tokens have been allocated to that range. In addition, the slide bar 110 associated with the range “14,476 to 14,500” has been moved upward along the 0-100 scale so that 24 of the tokens have been allocated to that range. Furthermore, the slide bar 110 associated with the range “14,526 to 14,550” has been moved upward along the 0-100 scale so that the remaining 20 tokens have been allocated to that range. As can be appreciated from FIG. 6B, the point distribution changes in real time as the tokens are allocated. While each bin 104 previously had 50 points associated with it, the “14,501 to 14,525” bin is now worth 85 points, the “14,476 to 14,500” bin is now worth 53 points, the “14,526 to 14,550” bin is now worth 49 points, and each other bin (to which no tokens have been allocated) is worth 29 points.

FIG. 6C illustrates another example token allocation. In this figure, 85 tokens have been allocated to the “14,501 to 14,525” bin, 9 tokens have been allocated to the “14,476 to 14,500” bin, and the final 6 tokens have been allocated to the “14,526 to 14,550” bin. By increasing the number of tokens allocated to the “14,501 to 14,525” bin, that bin's score has increased to 98 points, thereby greatly increasing the chance of a charitable contribution being made if the future DJIA price falls within the “14,501 to 14,525” range. However, the number of points associated with the 14,476 to 14,500″ bin and the “14,526 to 14,550” bin have dropped to 22 and 19 points, respectively. Moreover, the points associated with the bins 104 in which no tokens were allocated have dropped to 13 points each. As can be appreciated from this example, the greater the number of tokens allocated to a particular bin 104, the greater the chances of the expert “winning” the charitable contribution if he or she was correct. If the expert is incorrect, however, and the actual DJIA price ends up falling outside of the “14,501 to 14,525” range, the chances of winning the charitable contribution are much smaller.

FIG. 6D illustrates a further example of token allocation. In this example, the risk expert has allocated all tokens to the “14,501 to 14,525” bin. As a consequence, the points associated with that bin 104 have increased to 100, meaning that the expert will win the charitable contribution if he or she turns out to be correct. If not, however, the expert will not likely win the charitable contribution because each other bin 104 is worth 0 points.

In some embodiments, the elicitation interface 100 can include multiple preset buttons that, when selected, automatically allocate tokens according to a predetermined rule. In the examples of FIGS. 6A-6G, the preset buttons include a “Latest” button 114, a “10 Day Low” button 116, a “10 Day High” button 118, a “10 Day Range” button 120, a “Uniform” button 122, a “Previous Allocation” button 124, and a “Clear” button 126. The “Latest,” “10 Day Low,” and “10 Day High” buttons 114-118 can be used to show the latest price of the index, the 10-day low of the index, and the 10-day high of the index, respectively. In each case, all of the tokens will be allocated to the one bin 104 in which the price at issue falls. FIG. 6E shows an example result that occurred when the “Latest” button 114 was selected and the latest price of the DJIA index fell within the 14,476 to 14,500 range.

The “10 Day Range” button 120 can be used to allocate tokens to the bins 104 that span the range that the index occupied over the previous 10 days. FIG. 6F shows an example result that occurred when the “10 Day Range” button 120 was selected. In this example, the DJIA moved within a range of 14,475 to 14,625 and tokens were equally distributed (to the extent possible using whole numbers of tokens) over the six bins 104 associated with that range.

The “Uniform” button 122 can be used to uniformly distribute the tokens across each bin 104. FIG. 6G shows an example of this. In such a case, 10 tokens have been allocated to each of the 10 bins 104 to equally distribute the total 100 tokens.

The “Previous Allocation” button 124 can be used to automatically allocate the tokens in the same manner as they were previously allocated by the risk expert, for example, in the previous month.

The “Clear” button 126 resets the bins to the initial default state (see FIG. 6A) in which no tokens have been allocated.

The risk expert can adjust the token allocations and observe what they do to the point distribution across the various bins 104. Once the expert is satisfied with his or her allocations, the expert can select the “Submit” button 128 to submit his or her response.

With reference back to FIG. 4, the expert's response can be received as a subjective probability distribution, as indicated in block 66. At this point, flow depends upon whether or not there is a further index for which to elicit a belief from the expert, as indicated in decision block 68. If so, flow returns to block 62 and a similar elicitation interface is presented to the expert for the next index. If the expert has submitted a subjective probability distribution for each index of interest, however, flow continues on to block 70 and the subjective probability distributions of the expert are stored in association with his or her identity.

Turning next to decision block 72, flow depends upon whether there is another risk expert from which to elicit an opinion. If so, flow returns to block 60 and the above-described process is performed again but for a different expert. This process continues until all of the subjective probability distributions have been obtained from each expert. Of course, the method of FIG. 4 can be performed for each expert in parallel.

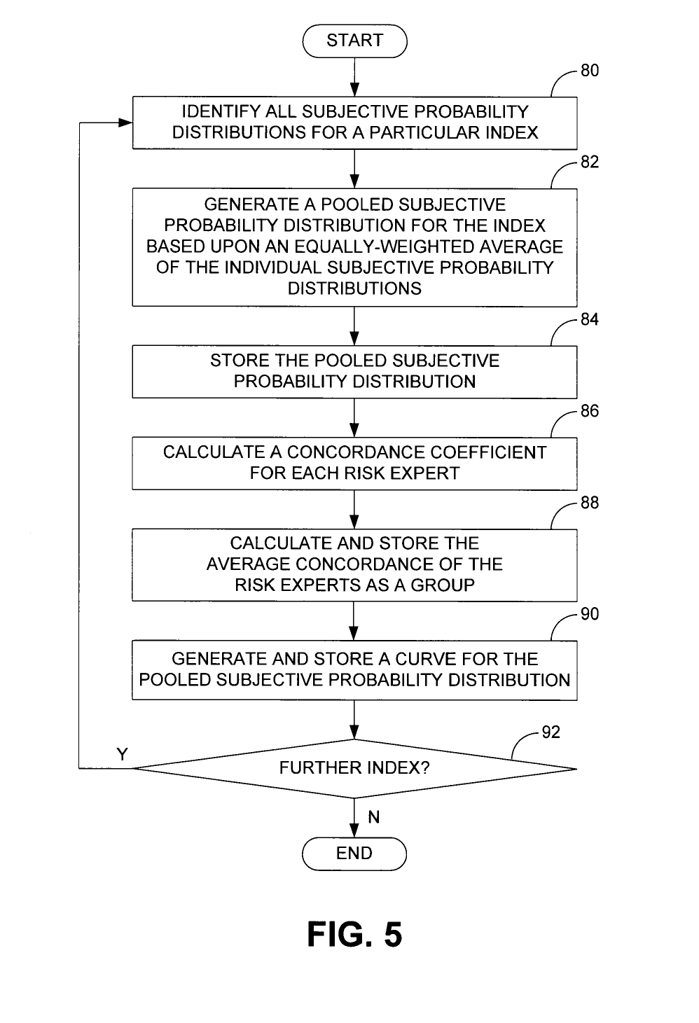

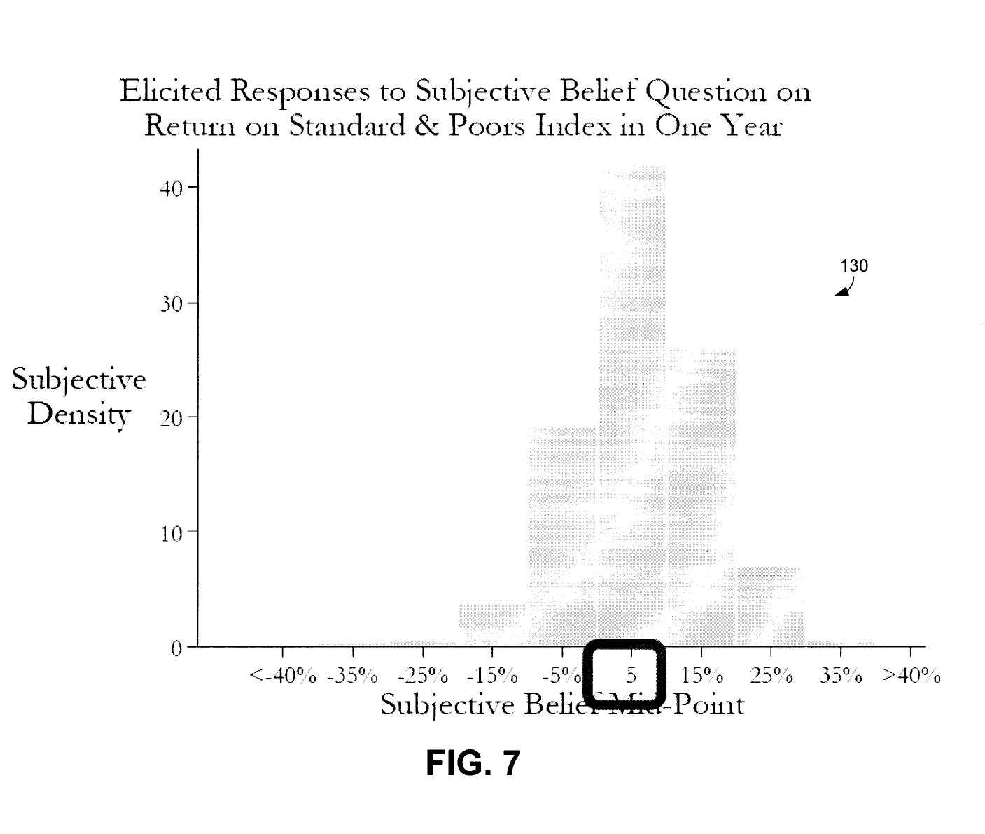

With reference again to FIG. 3, once all of the subjective probability distributions have been obtained, a pooled subjective probability distribution can be generated based upon the individual subjective probability distributions, as indicated in block 44, and the concordance between the experts can be determined for each index, as indicated in block 46. FIG. 5 illustrates an example methodology for achieving this. Beginning with block 80 of that figure, all of the subjective probability distributions for a given index are identified. A pooled subjective probability is then generated based upon an equally-weighted average of the individual subjective probability distributions, as indicated in block 82. FIG. 7 is an example of such a pooled subjective probability distribution, which shows the aggregated belief of a group of risk experts as to the future of the S&P 500. In the example of FIG. 7, the pooled subjective probability distribution concerns the expected percentage change of the S&P 500 index rather than the expected price of the index. As shown in the figure, the pooled result shows an aggregate belief that the S&P 500 index will most likely increase by 5% at the end of the time period at issue (in one year in this example).

With reference back to block 84 of FIG. 5, the pooled subjective probability distribution can be stored. Next, the concordance coefficient can be calculated for each risk expert, as indicated in block 86, and an average concordance of the experts as a group can be calculated and stored, as indicated in block 88.

At this point, the CRO risk index can be generated. In some embodiments, the CRO risk index is generated as a series of curves, one for each index, that depict the aggregated expert beliefs as to the future of the indices. Accordingly, as shown in block 90, a curve can be generated for the pooled subjective probability distribution relating to the index of interest.

As indicated in decision block 92, flow from this point depends upon whether or not there is another index for which to generate a pooled subjective probability distribution curve. If so, flow returns to block 80 and the above-described process is repeated for the next index.

With reference once again to FIG. 3, an objective probability distribution can be generated for each of the risk indices, as indicated in block 48, to obtain a baseline against which the pooled subjective probability distributions can be compared. In some embodiments, the objective probability distribution is generated using factor-augmented VAR in the manner described above.

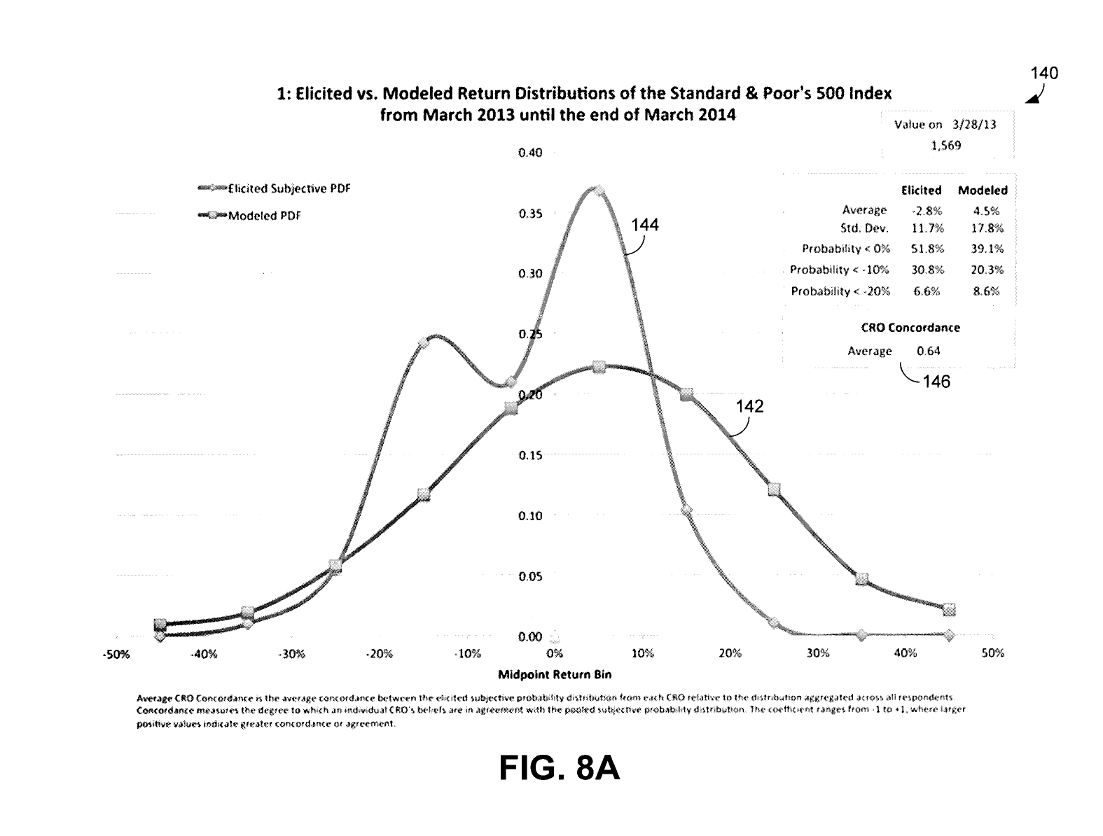

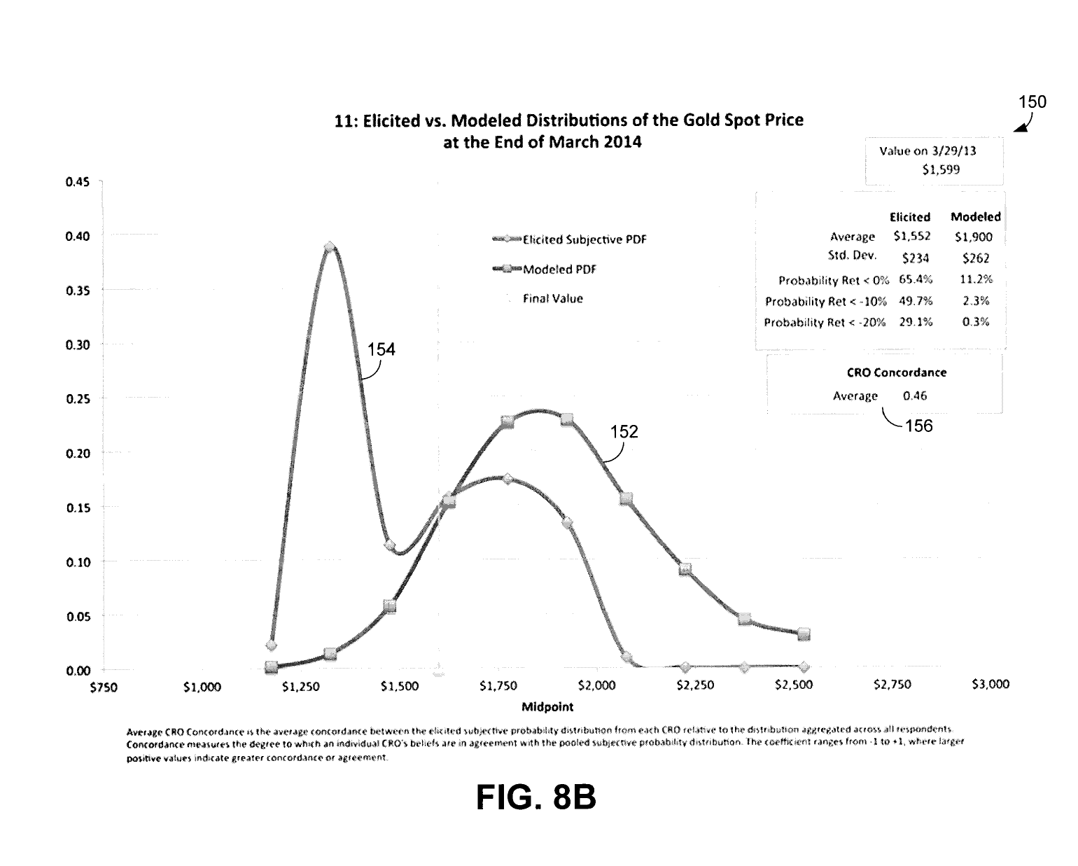

At this point, the objective probability distribution, the pooled subjective probability distributions, and the concordance for each index can be presented to users, as indicated in block 50. In some embodiments, this information can be published on the Internet for viewing by the general public. For example, graphs can be published for each index that include curves for the objective probability distribution and the pooled subjective probability distributions. In addition, the expert concordance for the index can also be presented on each graph. FIG. 8A provides an example graph 140 for the S&P 500. Objective and subjective probability distributions 142 and 144 are provided that both suggest that the S&P 500 will gain between 0 and 10% over the period from March 2013 to March 2014. As is shown in the inset box 146, the concordance for the pooled subjective probability distribution was 0.64. FIG. 8B provides an example graph 150 for the gold spot price. Objective and subjective probability distributions 152 and 154 appear to suggest different levels for gold over the period from March 2013 to March 2014. As is shown in the inset box 156, the concordance for the pooled subjective probability distribution was 0.46. Similar graphs can be provided for each risk index and together form a CRO risk index that financial professionals and others can consult as desired.

As described above, the underlying data behind the pooled subjective probability distributions can be made available to certain individuals. For example, the data can be made available in return for a paid subscription. In such a case, subscribers would be able to examine the raw data and formulate their own opinions as to risk based upon the data.

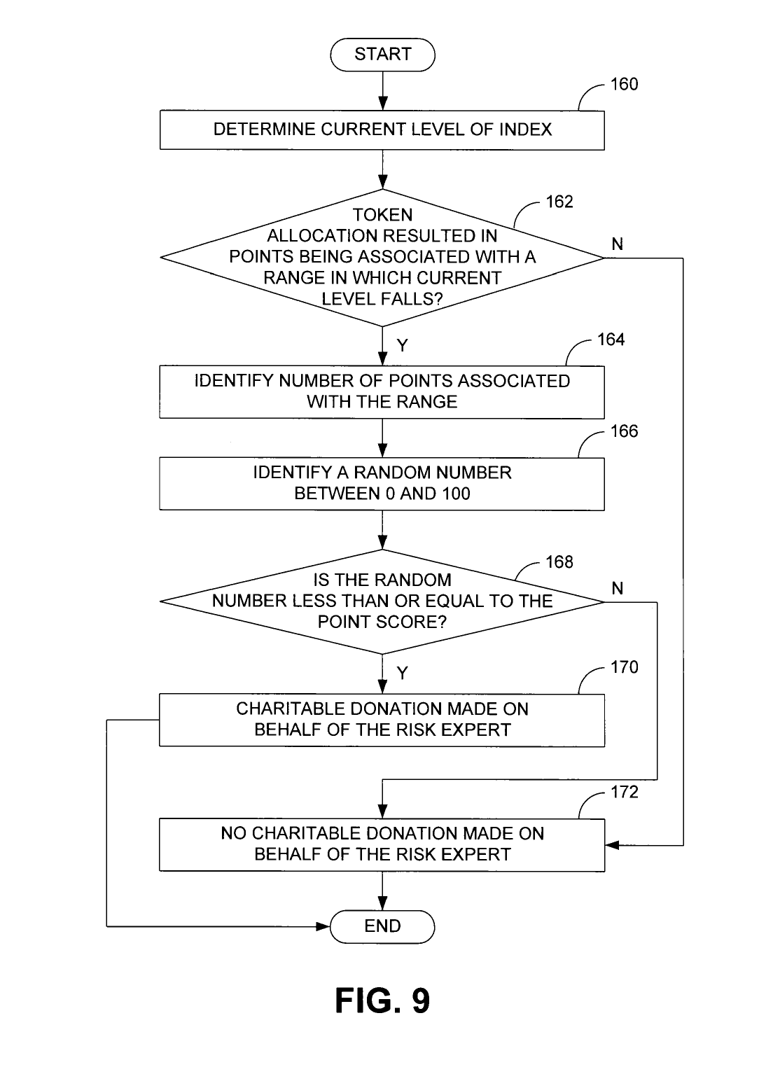

As was also described above, incentive is provided to the risk experts in the form of possible charitable contributions on their behalf. FIG. 9 illustrates an example process with which it can be determined whether or not such a contribution is made. Beginning with block 160, the current level of an index is determined. For example, if the S&P 500 was one of the indices for which a forecast had been made, for example, one year prior, it can be determined what the present level of the S&P 500 is upon closing. It is noted, however, that while the level of the index has been identified, if the forecast was made in regard to the percentage change of the index, the level can be the level of the percentage change.

Referring next to decision block 162, it is determined whether or not the risk expert's previous token allocation resulted in points being associated with a range in which the current level falls. For example, if the current level of the S&P 500 is 1605 and the expert's token allocation resulted in points being associated with a range of 1600-1625, the token allocation did result in points being associated with a range in which the current level falls. In such a case, flow continues to block 164. If not, however, no charitable donation is made on behalf of the expert, as shown in block 172.

Assuming the question of block 162 is answered in the affirmative, the number of points that were associated with the range is identified, as indicated in block 164. Next, a random number between 0 and 100 is identified, as indicated in block 166. As mentioned above, the number can be produced by a random number generator. In some embodiments, however, the randomly generated number can be a number that is publicly generated and over which no one has direct control, such as the first and second decimals of the closing price of the DJIA (“00” treated as “100”).

Flow from this point depends upon whether the random number is less than or equal to the risk expert's point score, as indicated in decision block 168. If not, meaning the random number is larger than the number of points that were associated with the range in which the current level falls, flow proceeds to block 172 and no charitable donation is made. If, on the other hand, the random number does not exceed the point score, flow continues to block 170 and a charitable donation is made on behalf of the risk expert. In some embodiments, the donation can be made to a charity of the expert's choice. Regardless, the donation can either be made in the expert's name or not, according to his or her wishes.

The elicitation and forecasting activities described above have been implemented. The initial results, the manner in which the results are characterized, and the nature of insights obtained from the results are discussed below.

The experts in the subjective elicitation were recruited to join The Risk Council of The Georgia State University CRO Risk Index (http://www.gsucroriskindex.org/). The Risk Council comprises the risk experts that participate in the monthly elicitation, and membership is limited to senior risk professionals. By limiting participation to risk managers, the opinions of highly-skilled professionals explicitly charged with forming opinions about the risks their firms face but who themselves are not allowed to personally participate in markets were solicited.

The required duties of members of the Risk Council involve participating in the monthly elicitation. The system was designed in recognition of the limited time that senior executives can allocate to this task. The web-based elicitation tool is designed so that users should be able to complete the monthly tasks within 15 minutes.

Risk Council members receive several benefits apart from the incentives for charitable contributions built into the elicitation procedure. Participants are also entitled to a free subscription access to an anonymous version of the individual response data and networking opportunities with other participants at optional roundtable events.

The recruitment of a CRO from a major corporation is a labor-intensive and network-intensive activity. Potential respondents were contacted and informed of the nature of the exercise. Many needed to obtain “legal” approval to participate, which is to be expected despite the confidential nature of the responses. Every respondent had the option to identify himself and his responses, but the default was to only reveal anonymous responses. The majority chose to keep their individual responses anonymous.

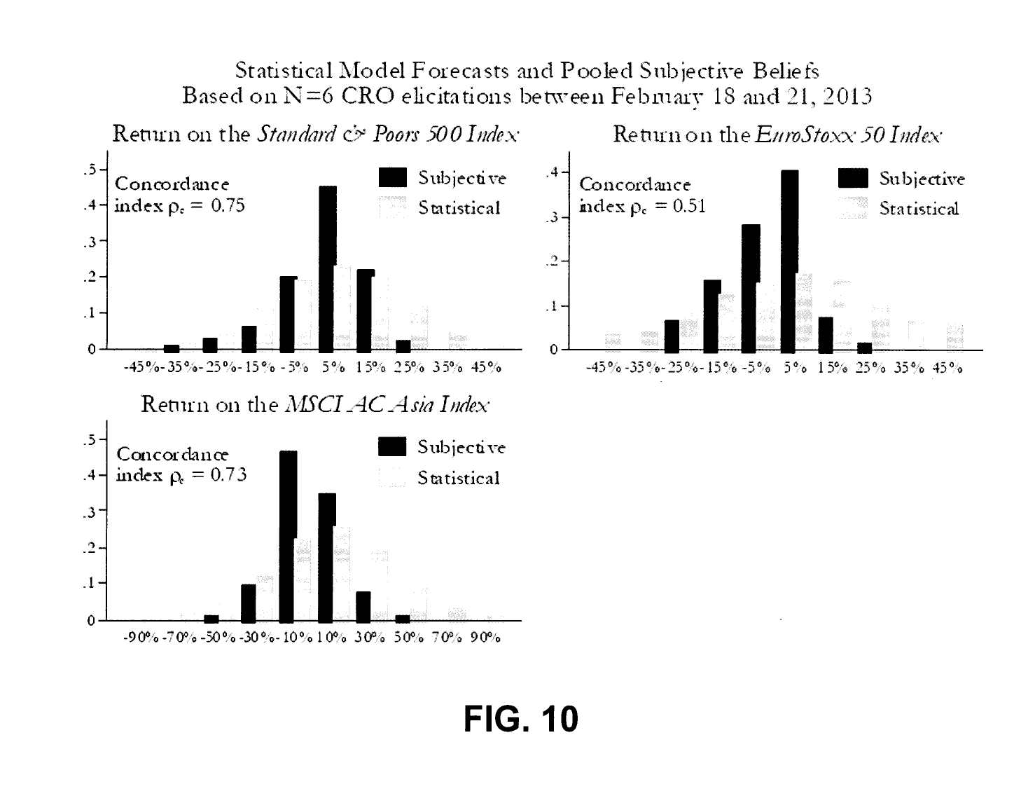

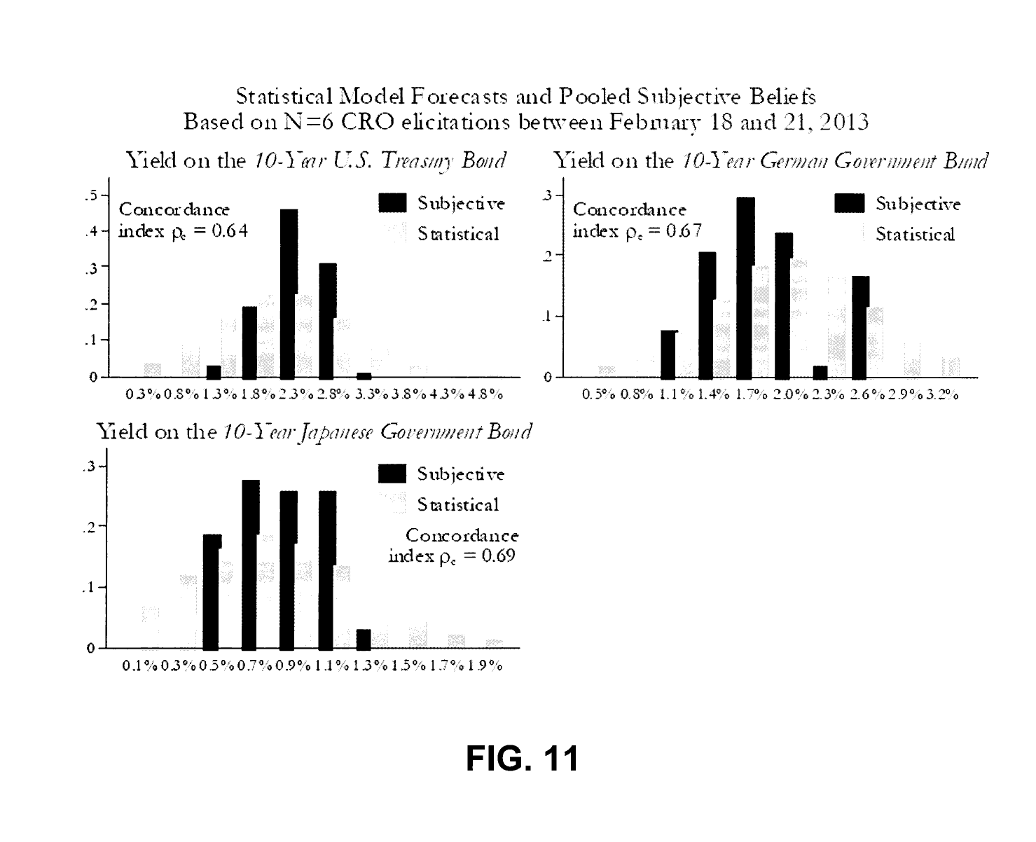

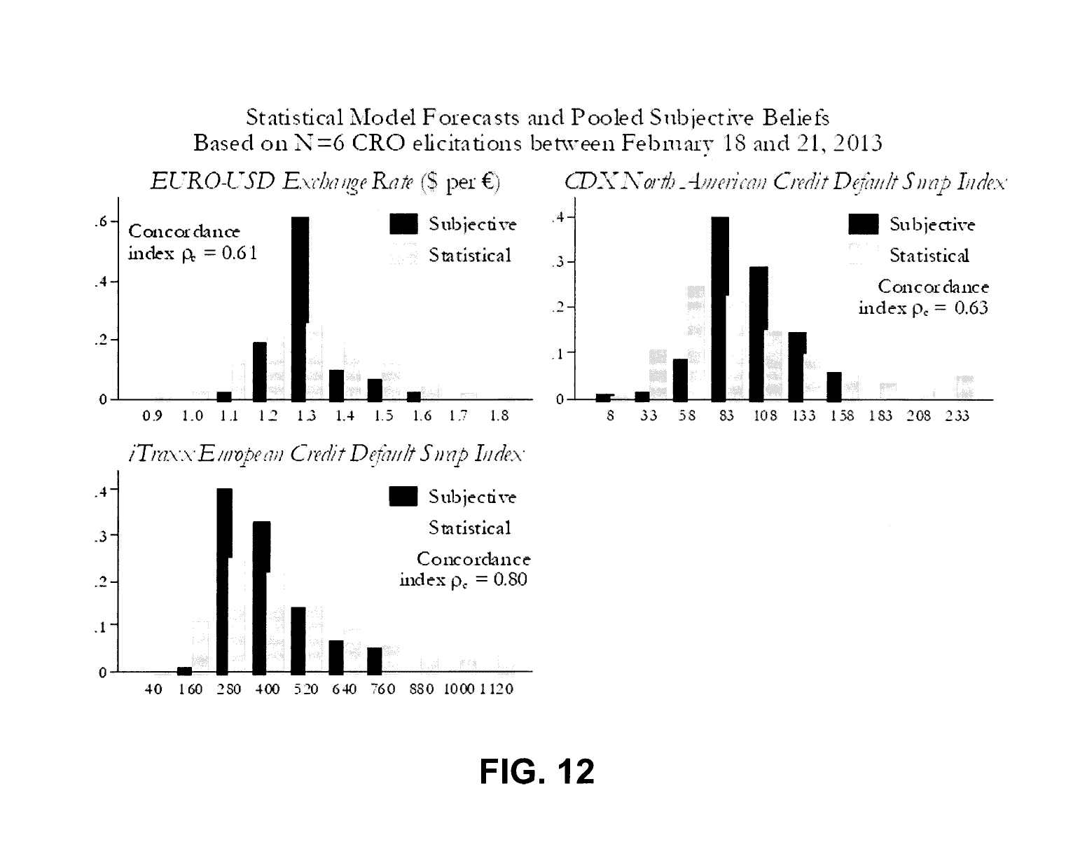

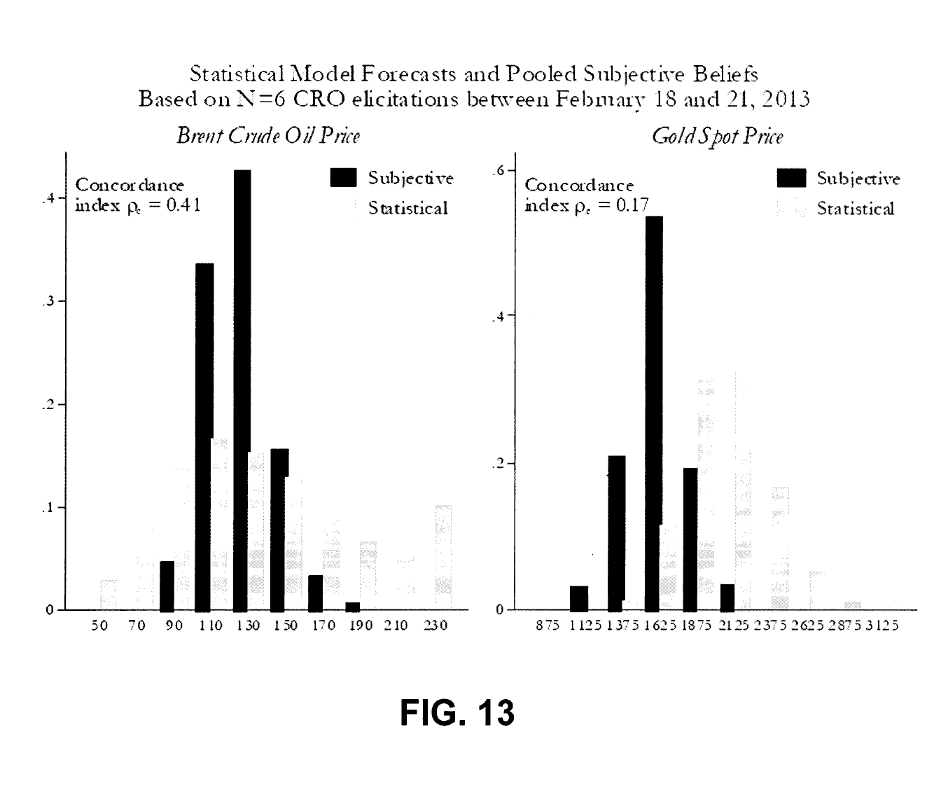

Table 1 summarizes the main findings for the elicited subjective beliefs and the statistical model used as a reference distribution. FIGS. 10 through 13 show the comparison of the statistical forecast and pooled subjective beliefs for each risk. In particular, FIG. 10 shows results for three equity indices, FIG. 11 shows results for three interest rates, FIG. 12 shows results for three financial indices, and FIG. 13 shows results for two commodity prices.

TABLE 1
Summary of Elicitation Results for February 2013

| Value on | Forecast Index | | Percentage | | Probability Return | | | Probability Rate Rises | | | |
|---|---|---|---|---|---|---|---|---|---|---|---|
| Jan. 31, | | Standard | | Standard | Declines | | | >0 | >50 | >100 | |
| 2013 | Average | Deviation | Change | Deviation | <0% | <−10% | <−20% | bps | bps | bps | Agreement |

Standard & Poor's 500 Index

| | | | | | | | | | | |
|---|---|---|---|---|---|---|---|---|---|---|
| Subjective | 1,498 | 1,545 | 161 | 3.2% | 11% | 30% | 10% | 4% | 0.71 | “within” |
| Statistical | 1,498 | 1,566 | 266 | 4.6% | 18% | 39% | 20% | 8% | 0.75 | “between” |

Eurostoxx 50 (European Blue Chip, excluding the U.K.) Index

| | | | | | | | | | | |
|---|---|---|---|---|---|---|---|---|---|---|
| Subjective | 2,703 | 2,651 | 292 | −2% | 11% | 51% | 22% | 7% | 0.70 | “within” |
| Statistical | 2,703 | 2,799 | 639 | 4% | 24% | 43% | 28% | 16% | 0.51 | “between” |

MSCI AC Asia (excluding Japan) Index

| | | | | | | | | | | |
|---|---|---|---|---|---|---|---|---|---|---|
| Subjective | 556 | 546 | 92 | −2% | 17% | 57% | 34% | 11% | 0.80 | “within” |
| Statistica | 556 | 595 | 172 | 7% | 31% | 41% | 29% | 19% | 0.73 | “between” |

10-Year U.S. Treasury Bond Yield

| | | | | | | | | |
|---|---|---|---|---|---|---|---|---|
| Subjective | 1.99% | 2.29% | 0.40% | 79% | 33% | 2% | 0.75 | “within” |
| Statistical | 1.99% | 1.98% | 0.82% | 50% | 27% | 11% | 0.64 | “between” |

10-Year German Bond Yield

| | | | | | | | | |
|---|---|---|---|---|---|---|---|---|
| Subjective | 1.68% | 1.77% | 0.44% | 54% | 18% | 1% | 0.59 | “within” |
| Statistical | 1.68% | 1.90% | 0.61% | 64% | 33% | 10% | 0.67 | “between” |

10-Year Japanese Government Bond Yield

| | | | | | | | | |
|---|---|---|---|---|---|---|---|---|
| Subjective | 0.75% | 0.84% | 0.23% | 60% | 2% | 0% | 0.52 | “within” |
| Statistical | 0.75% | 1.79% | 0.42% | 51% | 14% | 2% | 0.69 | “between” |

Euro/USD Exchange Rate

| | | | | | | | | | | |
|---|---|---|---|---|---|---|---|---|---|---|
| Subjective | 1.36 | 1.32 | 0.09 | −3% | 6% | 76% | 12% | 0% | 0.68 | “within” |
| Statistical | 1.36 | 1.33 | 0.16 | −2% | 12% | 59% | 25% | 5% | 0.61 | “between” |

CDX North American Credit Default Swap Index

| | | | | | | | | |
|---|---|---|---|---|---|---|---|---|
| Subjective | 89 | 97 | 28 | 59% | 9% | 0% | 0.63 | “within” |
| Statistical | 89 | 101 | 66 | 47% | 18% | 8% | 0.63 | “between” |

iTraxx European Credit Default Swamp Index

| | | | | | | | | |
|---|---|---|---|---|---|---|---|---|
| Subjective | 443 | 401 | 137 | 31% | 22% | 16% | 0.64 | “within” |
| Statistical | 443 | 500 | 345 | 45% | 37% | 31% | 0.80 | “between” |

Brent Crude Oil Price

| | | | | | | | | | | |
|---|---|---|---|---|---|---|---|---|---|---|
| Subjective | $116 | $126 | $18 | 9% | 16% | 31% | 11% | 3% | 0.85 | “within” |
| Statistical | $116 | $143 | $62 | 24% | 53% | 37% | 28% | 19% | 0.41 | “between” |

Gold Sport Price

| | | | | | | | | | | |
|---|---|---|---|---|---|---|---|---|---|---|
| Subjective | $1,664 | $1,623 | $202 | −2% | 12% | 80% | 50% | 20% | 0.79 | “within” |
| Statistical | $1,644 | $2,061 | $284 | 24% | 17% | 6% | 1% | 0% | 0.17 | “between” |

In this particular elicitation, FIG. 10 and Table 1 show that the subjective beliefs are generally more pessimistic than the statistical forecast with respect to prospects for equities over 2013, particularly for European and Asian equities. For the U.S and Asia, the subjective beliefs put less weight on good or bad extremes and tended towards a small overall increase in returns for the U.S. However, the subjective beliefs are decidedly pessimistic with respect to European and Asian equities, on balance expecting a decline in returns and not just a small positive return as in the U.S. The concordance indices point to relatively more disagreement between the two modeling approaches with respect to European equities.

FIG. 11 and Table 1 show that the subjective beliefs point to far less tail risk than the statistical forecast with respect to prospects for major interest rates over 2013. The standard deviation in elicited beliefs is much smaller than the corresponding measure for the statistical model for each interest rate considered.

FIG. 12 displays perhaps the most striking result of the belief elicitation. Although there is considerable unanimity between the subjective beliefs and the statistical forecast with respect to the [symbol] /$ exchange rate, there is a clear difference when it comes to credit default risk. The subjective beliefs and statistical model suggest a higher cost of hedging credit risk in the U.S. over 2013. The subjective beliefs and statistical model have a striking contrast, however, when it comes to the cost of hedging credit risk in Europe. The subjective beliefs indicate a fall in those costs, whereas the statistical model predicts an increase.

FIG. 13 also contains some surprises. The subjective beliefs are generally far less pessimistic than the historical forecast with respect to oil prices and gold prices over 2013, although both agree on expected increases in the price of oil. The difference is particularly striking for gold, with a concordance index of only 0.17 between the subjective distribution and statistical distribution. If one looks at the historical trend of gold prices in the past 5, 10, 15, or 20 years, no data-bound statistical model has any place to go but above $2,000 per ounce. The subjective beliefs of the experts point to virtually no change from current gold prices. Similarly, the experts do not anticipate oil getting close to $200 per barrel within 2013, whereas the statistical model places non-negligible probability on that event occurring. The disagreement between the two distributions in the case of oil is mainly about one upper tail.

Claimed are:

1. A method for forecasting financial risk, the method comprising:
eliciting from multiple risk experts subjective probability distributions regarding the future of a risk index;
generating a pooled subjective probability distribution for the index based upon the individual subjective probability distributions; and
presenting the pooled subjective probability distribution to users.

2. The method of claim 1, wherein eliciting comprises presenting an elicitation interface to the risk experts with which the experts can allocate tokens to particular ranges of the index.

3. The method of claim 2, wherein eliciting further comprises receiving the risk experts' token allocations and associating point scores with the ranges in accordance with the token allocations.

4. The method of claim 3, wherein the point scores are related to the token allocations according to a quadratic scoring rule.

5. The method of claim 3, wherein associating point scores comprises displaying changes in the point scores to the experts in real time so that they appreciate the effect of the token allocation on the point scores.

6. The method of claim 3, further comprising determining whether or not the risk experts are to be rewarded for their token allocations.

7. The method of claim 6, wherein determining whether or not the risk experts are to be rewarded comprises identifying a point score for the expert associated with a range in which a future level of the index falls, identifying a random number, comparing the random number to the point score, and rewarding the expert if the random number is less than or equal to the point score.

8. The method of claim 7, wherein rewarding the risk expert comprises making a charitable contribution on the behalf of the expert.

9. The method of claim 1, wherein generating a pooled subjective probability distribution comprises generating a pooled subjective probability distribution based upon an equally-weighted average of the individual subjective probability distributions.

10. The method of claim 1, further comprising generating a curve for the pooled subjective probability distribution.

11. The method of claim 10, wherein presenting the pooled subjective probability distribution comprises publishing the curve.

12. The method of claim 11, further comprising generating an objective probability distribution curve for the risk index and publishing the objective probability distribution curve along with the pooled subjective probability distribution curve.

13. The method of claim 12, wherein generating objective probability distributions comprises performing factor-augmented vector autoregression for the index.

14. The method of claim 1, further comprising determining a concordance of the risk experts and presenting the concordance to the users along with the pooled subjective probability distribution.

15. A non-transitory computer-readable medium that stores a risk index generator comprising:
logic configured to present an elicitation interface to risk experts that elicits subjective probability distributions regarding the future of a risk index;
logic configured to generate a pooled subjective probability distribution for the index based upon the individual subjective probability distributions, and
logic configured to present the pooled subjective probability distribution to users.

16. The computer-readable medium of claim 15, wherein the elicitation interface enables the risk experts to allocate tokens to particular ranges of the index.

17. The computer-readable medium of claim 16, wherein the risk index generator is configured to associate point scores with the ranges in accordance with the token allocations.

18. The computer-readable medium of claim 17, wherein the point scores are related to the token allocations according to a quadratic scoring rule.

19. The computer-readable medium of claim 17, wherein the risk index generator is configured to display changes in the point scores to the experts in real time so that the they appreciate the effect of the token allocation on the point scores.

20. The computer-readable medium of claim 17, wherein the risk index generator is further configured to determine whether or not the risk experts are to be rewarded for their token allocations.

21. The computer-readable medium of claim 20, wherein the risk index generator determines whether or not the risk expert is to be rewarded by identifying a point score for the expert associated with a range in which a future level of the index falls, identifying a random number, comparing the random number to the point score, and rewarding the expert if the random number is less than or equal to the point score.

22. The computer-readable medium of claim 15, wherein the risk index generator is configured to generate the pooled subjective probability distribution based upon an equally-weighted average of the individual subjective probability distributions.

23. The computer-readable medium of claim 15, wherein the risk index generator is further configured to generate a curve for the pooled subjective probability distribution.

24. The computer-readable medium of claim 23, wherein the risk index generator is further configured to generate an objective probability distribution curve for the risk index and present the objective probability distribution curve along with the pooled subjective probability distribution curve.

25. The computer-readable medium of claim 24, wherein the risk index generator is configured to generate the objective probability distribution curve by performing factor-augmented vector autoregression for the index.

26. The computer-readable medium of claim 15, wherein the risk index generator is further configured to determine a concordance of the risk experts and present the concordance to the users along with the pooled subjective probability distribution.

27. An elicitation interface for eliciting beliefs as to the future of a risk index, the interface comprising:
multiple bins to which tokens can be allocated, each bin being associated with a particular range of the risk index;
at least one level bar associated with a bin, each level bar communicating a point score associated with the bin; and
a slide bar associated with each bin, each slide bar being actuable by a user to allocate tokens to its associated bin.

28. The elicitation interface of claim 27, wherein the interface updates the point scores in real time as token allocations are changed so the allocator can appreciate the effect of changing token allocations.

29. The elicitation interface of claim 27, further comprising buttons that, when selected, automatically allocate tokens to the bins according a preset rule.
